(19) United States
(12) Patent Application Publication
(10) Pub. No.: US 2025/0344901 A1
(43) Pub. Date: Nov. 13, 2025

(54) Grill Top Pizza Oven and Base

(71) Applicant: Roger Clive Henderson, Boise, ID (US)

(72) Inventor: Roger Clive Henderson, Boise, ID (US)

(21) Appl. No.: 19/203,646

(22) Filed: May 9, 2025

Related U.S. Application Data
(60) Provisional application No. 63/645,137, filed on May 10, 2024.

(51) Int. Cl. A47J 37/06; A47J 37/07; F24C 3/00

(52) U.S. Cl. CPC A47J 37/0658; A47J 37/0647; A47J 37/0713; A47J 37/0786; F24C 3/002

(57) ABSTRACT

A grill top pizza oven is removably positioned on the grill of a barbecue grill such that the lid of the barbecue grill closes over and around the grill top pizza oven. The oven has a chamber in which the pizza is cooked. The chamber floor is formed by a pizza cooking surface, such as a pizza stone. The top of the chamber is configured for pizza(s) to be positioned on the roof such that pizza remains warm from the heat within the barbecue grill. The grill top pizza oven receives heat from the barbecue grill heat source below the grill and has a second heat source that heats the chamber above the chamber floor. The grill top pizza oven has a vent that extends out of the barbecue grill to vent the chamber.

### CROSS-REFERENCE TO RELATED APPLICATIONS

This application claims the benefit of U.S. Provisional Application No. 63/645,137, filed May 10, 2025 the disclosure of which is incorporated by reference.

### FIELD OF THE INVENTION

The presently disclosed technology relates to an improved device for cooking pizza utilizing a grill. More particularly, the present invention is an insert that is positioned onto a barbecue grill and optionally can be utilized with an independent cooking base.

### BACKGROUND OF THE INVENTION

Traditional barbecue grills use a grill positioned over a heat source. Barbecue grills typically have a lid that closes over the grill to prevent heat from leaving the grill and provide some indirect heating to the top of the food being grilled. While this works well for cooking many varieties of food, it is not ideal for cooking pizza. Different varieties of pizza require very different temperatures and sources of cooking heat. Some require even temperatures for both the top and bottom of the pizza, others require more heat on the top and less on the bottom. Ovens that heat from just the bottom frequently do not cook toppings correctly as the pizza dough and toppings do not cook at the same rate. Ovens that cook from just the top typically lack control to maintain the bottom temperature.

An ideal pizza oven needs to have the ability to control both accurately and with the flexibility to change temperatures during the cooking process. Ovens also need to pre-heat in a reasonable amount of time and recover cooking temperatures quickly to cook multiple pizzas. When serving multiple pizzas, it is highly beneficial for an oven to provide the ability for serving multiple hot pizzas at the same time even if the oven is limited to cooking one pizza at a time.

A barbecue grill is a significant investment of money. They are also appliances that require significant setup and space. Stand-alone pizza ovens are also costly investments that require space and setup. Barbecue ovens and pizza ovens overlap in so many aspects, that it is hard to justify two appliances that each do a partial job in precision cooking.

There are also contraptions that are added to barbecue grills to try to create pizza ovens. While these will succeed in cooking a pizza, they typically do not maintain precision cooking temperatures for the top and bottom of pizzas. These devices also typically do not have additional cooking/warming surfaces such that multiple pizzas can be cooked sequentially, yet served simultaneously with the earliest cooked pizza being hot. Furthermore, it would be would be great to be able to use a device on a home barbecue grill, and have the ability to use the device as a portable pizza oven independent of a large home grill. Ideally, the device would be adaptable to a variety of barbecue grills on the market.

### SUMMARY

Accordingly, the inventive concepts disclosed herein provide an add-on accessory that converts a standard barbecue grill into a complete pizza oven. The grill top pizza oven allows the user to utilize existing barbecue equipment and create a pizza oven that exploits the existing space and costs associated with a barbecue grill. The invention can also be attached to a multi-function cooking base to be used as a stand-alone pizza oven. The invention includes a heating surface to enable the user to cook and serve multiple hot pizzas or other items at the same time.

What is disclosed is a grill top pizza oven for positioning on the grill of a barbecue grill. The barbecue grill having a barbecue grill heat source positioned below the grill and a lid for closing the barbecue grill to form a barbecue grill cooking space above the grill. The grill top pizza oven having a chamber defined by at least one chamber wall and a chamber top. A preferred embodiment has two opposing sidewalls and a back wall. The top surface of said chamber top is preferably a pizza staging surface, such as a pizza stone.

The grill top pizza oven has a base configured for positioning on the grill of the barbecue grill. This base can be formed as the end of the wall or sidewalls, or as a base attached to the bottom of the walls. A chamber heat source extends through the chamber wall and is configured to distribute heat into the chamber between the grill and the chamber top. A vent is positioned in the chamber wall for venting gases and heat from the chamber. The chamber wall defines a chamber opening configured to receive a pizza within said chamber for cooking of said pizza.

The grill top pizza oven has a floor positioned within the chamber on the grill. This floor is configured as a cooking surface, such as a cooking stone being the floor. The floor can be integral with the grill top pizza oven, or removable such as by a separate pizza stone that is placed into the chamber. Preferably the wall(s) and top of the chamber are configured to retain or reflect heat to increase the cooking function of the chamber.

The chamber heat source is a burner that extends through a wall of the grill top pizza oven. The heat source can be a gas burning burner, or an alternate fuel source such as wood or charcoal. Preferably the vent is positioned opposite of the burner such that exhaust gases from the burner agre directed to the vent. The vent is connected to vent conduit that extends through the lid to vent the grill top pizza oven. The vent can extend either through the top of the grill lid (a vertical vent) or through one of the sides of the grill lid (a horizontal vent) when the lid is closed.

The grill top pizza oven can be provided with a multipurpose cooking base. The multipurpose cooking base has a base cooking surface and a plurality of legs supporting the base cooking surface. The grill top pizza is also preferably rectangular or square with base serving as a footprint for the grill to pizza oven. Preferably four legs support a generally rectangular or square cooking surface. The legs are preferably foldable to increase the portability of the base. The grill top pizza oven can be interchangeably used between the grill and the portable base. The grill top pizza oven of claim 1 wherein said multipurpose cooking base comprises a base heat source positioned below said cooking surface. Preferably the base has a door configured to close said chamber opening.

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF DRAWINGS

FIG. 1 is a front view of an embodiment of a grill top pizza oven with the burner installed on the right side and venting installed on the left side.

FIG. 2 is a perspective view of the grill top pizza oven of FIG. 1 with no burner or venting installed.

FIG. 3 is a front view of the grill top pizza oven with no burner or venting installed.

FIG. 4 is a top view of the grill top pizza oven of FIG. 1 with no burner or venting installed.

FIG. 5 is a bottom view of the grill top pizza oven of FIG. 1 with no burner or venting installed.

FIG. 6 is a perspective view of a gas burner for a grill top pizza oven.

FIG. 7 is a perspective view of a non-gas burner for a grill top pizza oven.

FIG. 8 is a perspective view of a section of modular venting for a grill top pizza oven.

FIG. 9 is a perspective view of a section of 90-degree modular venting with adjustable damper for a grill top pizza oven.

FIG. 10 is a perspective view of a multi-function cooking base with a heating element and a door for an installed grill top pizza.

FIG. 11 is a perspective view of a multi-function cooking base with a heating element and a door for the grill top pizza oven installed.

FIG. 12 is a front view an assembly of the grill top pizza oven of FIG. 1 installed on the multi-function cooking base of FIG. 10.

FIG. 13 is a perspective view of the assembly of FIG. 12.

FIG. 14 is a perspective view of the grill top pizza oven of FIG. 1 installed on a large barbecue grill.

FIG. 15 is a perspective view of the grill top pizza oven installed on a large barbecue grill of FIG. 14 with the lid of the barbecue grill in a closed position.

FIG. 16a is a perspective view of a grill top pizza oven installed on a barbecue grill with the burner operational and a pizza in the grill top pizza oven.

FIG. 16b is a perspective view of the grill top pizza oven and barbecue grill of FIG. 16a without a pizza in the chamber.

FIG. 16c is a perspective view of the grill top pizza oven and barbecue grill of FIGS. 16a and 16b with the lid of the barbecue grill in the closed position.

FIG. 16d is a perspective view of the grill top pizza oven and barbecue grill of FIGS. 16a and 16b with a pizza in the cooking chamber and two pizzas on top of the chamber.

### DETAILED DESCRIPTION OF THE INVENTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

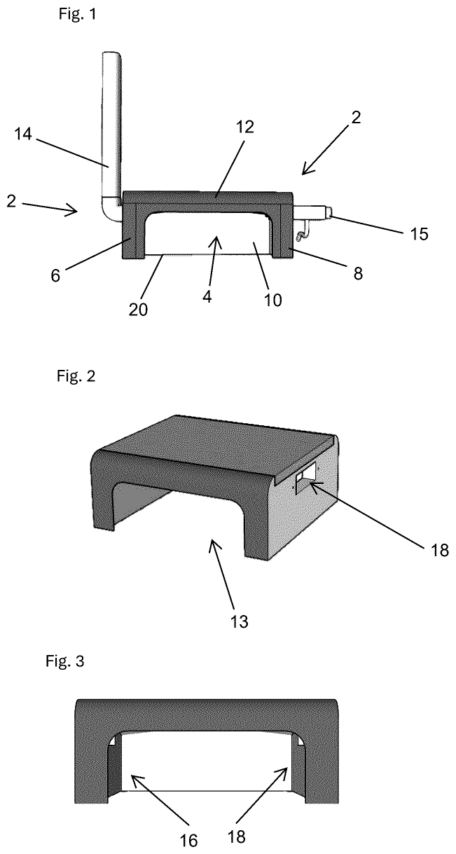

FIG. 1 illustrates an embodiment of a grill top pizza oven for positioning on a grill of a barbecue grill. The grill top pizza oven 2 has a chamber 4 formed by first side wall 6 second side wall 8 and back wall 10. The chamber has a top 12. The top is preferably formed or has attached or positioned thereon a pizza stone. The first side wall 6 has an aperture (illustrated in FIG. 3). The aperture is connected to a vent 14 that extends from the aperture through the lid of the barbecue grill. In the embodiment dedicated of FIG. 1 the vent extends upward through the top of the lid of the barbecue grill. Alternatively, the vent can extend through the side wall or the side wall of the barbecue grill is constructed to close around the vent. The top of the chamber is form of or lined with a heat reflective material for reflecting heat or flame downward away from the roof and toward a cooking pizza. Preferably the walls of the chamber are constructed of metal to make the device portable, strong, and lightweight.

The second side wall of the chamber has an aperture 18 through which heat is directed into the chamber from a chamber heat source being a burner. The burner can be a gas burner, such as propane or natural gas, or non-gas heat supply, such as charcoal or wood burning. The opposing side walls 6,8 and back wall 10 define a base 20 that is configured positioning on a grill of a barbecue grill. The base in the depicted embodiment is open to allow the heat generated from the heat source beneath the grill of the barbecue grill to the chamber from beneath. A pizza stone is then positioned in the chamber for cooking of pizza.

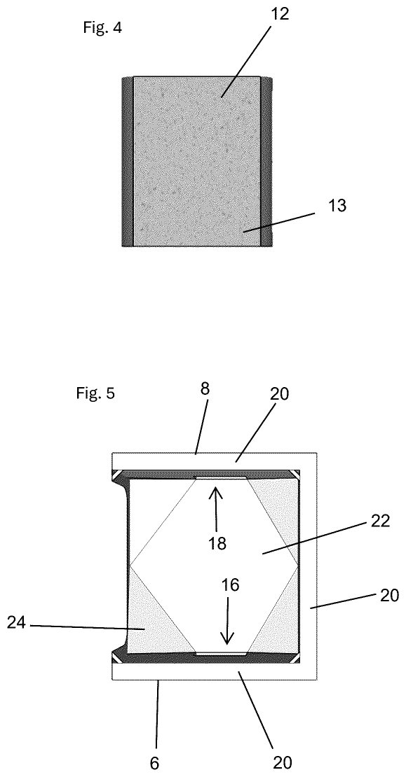

FIG. 4 illustrates the top 12 of the chamber. In the depicted embodiment a pizza stone 13 is positioned on top of the chamber as the top surface of the chamber top. In use, pizzas that have been cooked within the chamber are positioned on top of the chamber after the pizzas have reached a cooked state. This allows the pizzas to be staged while one or more additional pizzas are cooked within the chamber. This allows for a pizza chief to cook a series of pizzas and serve all at once.

FIG. 5 is a bottom view of the chamber without any venting or burner attached. The base 20 of the chamber is formed by the bottom of the two opposing side walls 6,8. In the depicted embodiment, a piece of metal 22 is positioned on the roof 24 of the chamber. The depicted metal is a corrugated, otherwise channeled metal that directs heat and exhaust across the roof. For example, if a burner is positioned in the location of the burner 15 in FIG. 1, heat is directed from the burner aperture 18 toward vent aperture 16.

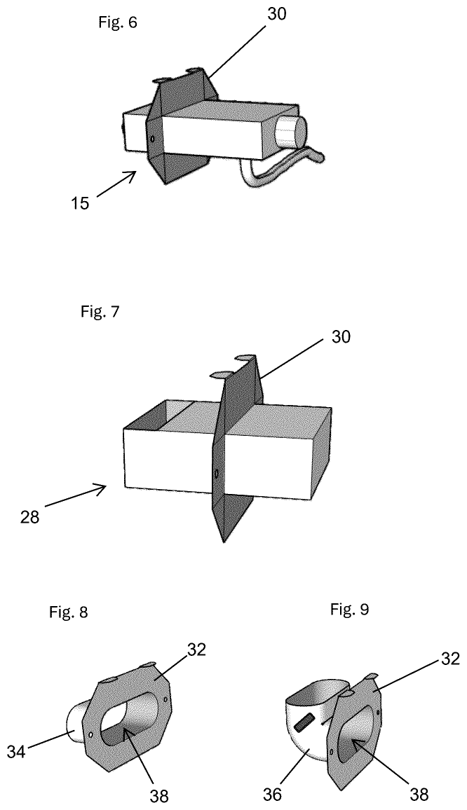

FIGS. 6 and 7 illustrate alternative embodiments of the chamber heat source being a burner for attachment through a wall of the chamber to deliver supplemental heat to the chamber. FIG. 6 illustrates a gas burner 15 as shown in FIG. 1. FIG. 7 illustrates an alternative source burner such as charcoal or wood. This alternative source burner 28 also includes a flange 30 for attaching the burner to the side wall of the chamber such that the burner extends in to the chamber to provide heat into the chamber.

FIGS. 8 and 9 illustrate two embodiments of vents that are configured with flanges 32 for connecting the vent to the side wall of the chamber. FIG. 8 illustrates a straight vent 34 and FIG. 9 illustrates a 90 degree curved vent 36. The straight vent is configured for venting the chamber out of the side of the lid of the barbecue grill. FIG. 9 depicts a vent that has an elbow to vent the exhaust gases out the top of the lid of the barbecue grill. Each vent attachment has vent aperture 38 which is in communication with the interior of the chamber through side wall apertures 16, 18 illustrated in FIG. 3.

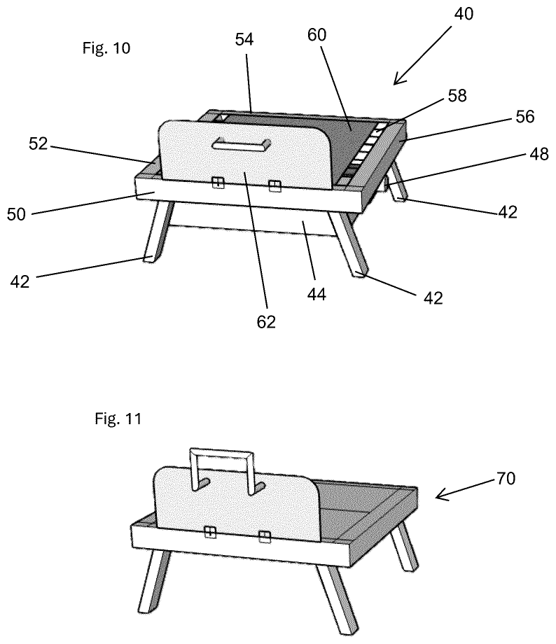

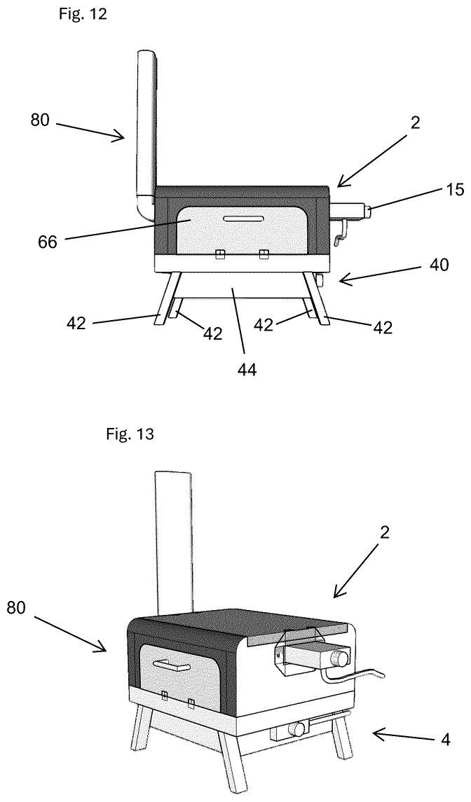

FIG. 10 illustrates a preferred embodiment of a pizza oven base that is configured to receive the pizza oven chamber of FIGS. 1-5. The depicted base has four legs 42 to provide a free standing base. Preferably these legs are folding to allow for increased supportability of the base. FIG. 10 illustrates a base that has an independent heating element 44 positioned beneath the cooking surface. In use, the chamber is positioned on to the base as shown in FIG. 12.

FIG. 11 illustrates an alternative view of the pizza oven base 70 without an integrated burner. The base can be formed with grooves in each side that accept the base of each side and back wall of the chamber. Alternatively, alignment protrusions, or other retention mechanisms can be utilized.

FIG. 11 illustrates an alternate embodiment at the base without an integral heating source. In this depicted embodiment the heat source of the chamber can be utilized for a supplemental heat source such as a fire can be positioned underneath the base.

FIG. 12 illustrates the grill top pizza oven 2 positioned on the base 40 of FIG. 10. The door 66 is positioned within the opening of the chamber. The door is opened to allow the pizza cooker to insert a pizza into the chamber and to remove the pizza from the chamber. The base heat source 44, such as a burner, in association with the chamber burner 15 provide for a dual heat source allowing for heat to be applied from beneath the chamber as well as the side of the chamber to the top of the chamber space. FIG. 13 illustrates an isometric side view of the assembly of FIG. 12. Preferably one or more securing devices, such as latches, secure the grill top pizza oven to the base.

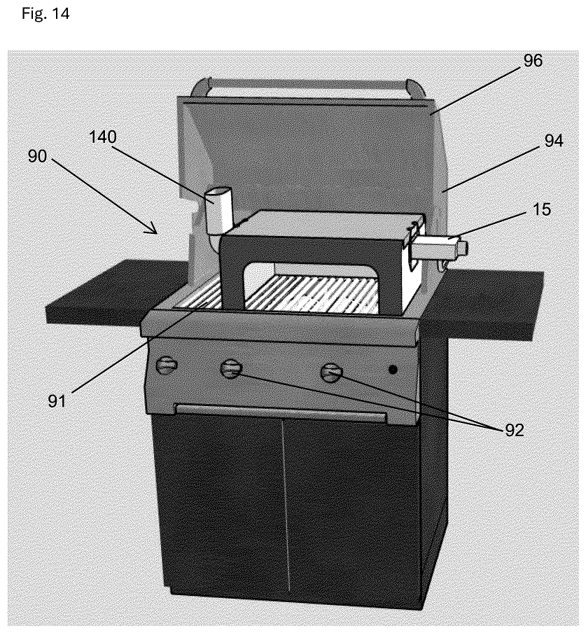

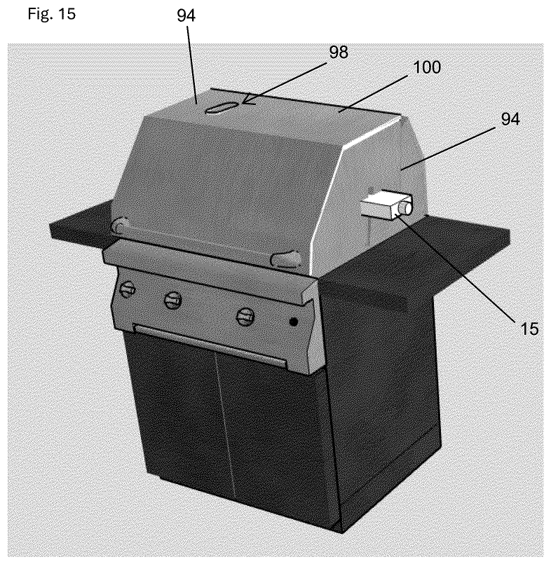

FIGS. 14 and 15 illustrate the grill top pizza oven of FIG. 1 positioned on a grill 91 of a barbecue grill 90. The chamber is configured to rest on to the grill such that the base of the chamber is positioned directly onto the grill. The burner of the barbecue grill is positioned beneath the grill and operated by barbecue grill controls 92. The chamber burner 15 extends beyond the side wall 94 of the lid 96 of the grill. The 90 degree vent conduit 140 is configured to extend through an aperture of the roof of the grill. FIG. 15 illustrates the lid of the barbecue grill in a closed positioned with the vent 140 extending through an aperture 98 in the top 100 of the lid of the grill.

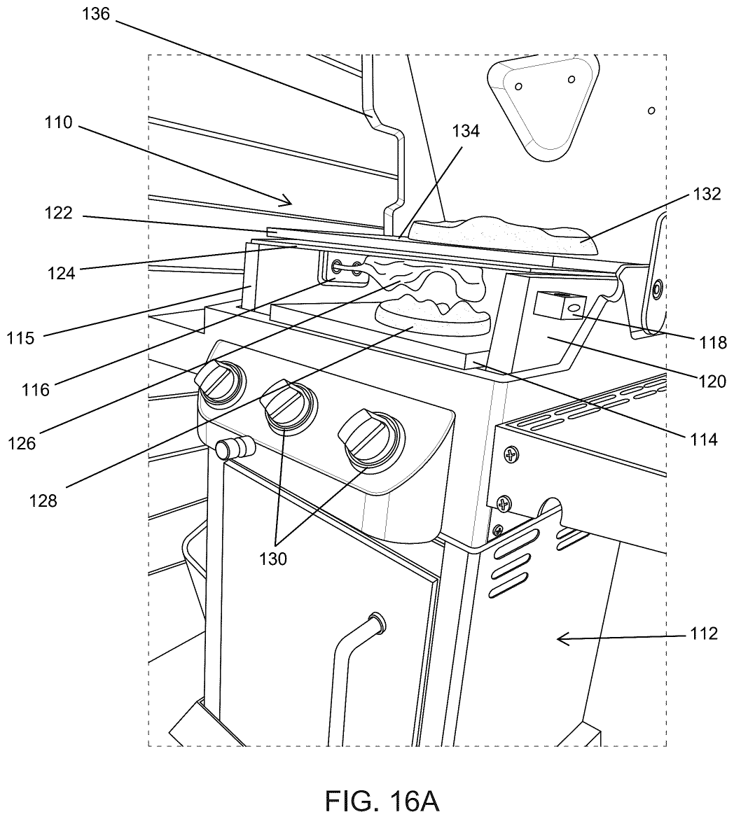

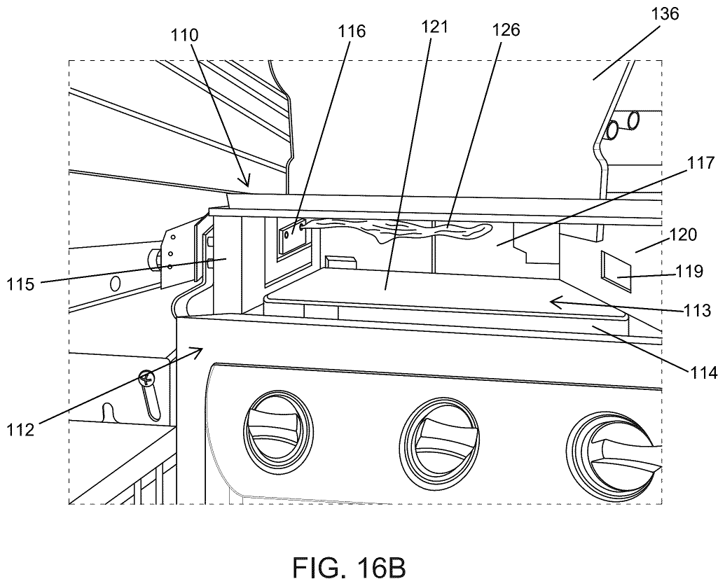

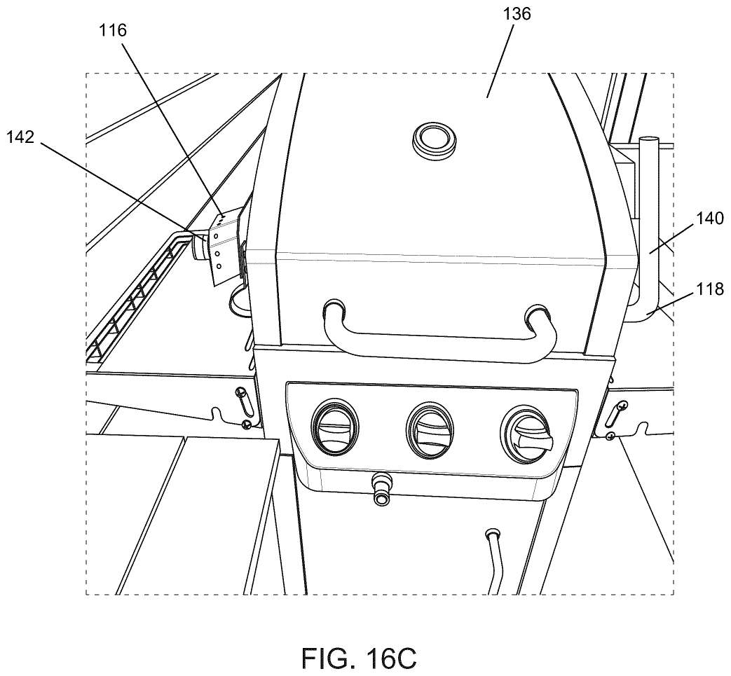

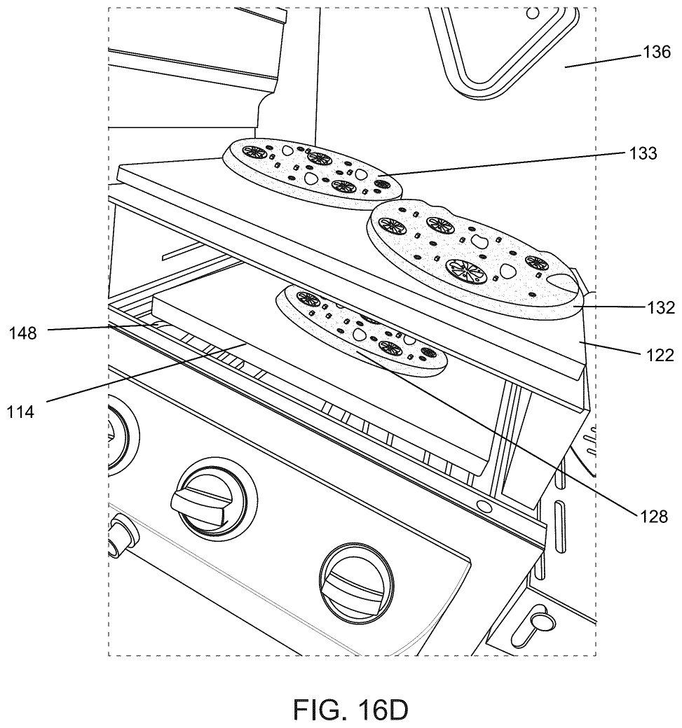

FIG. 16A illustrates an embodiment of the insert 110 positioned on top of a grill of a barbecue grill 112. The insert is a cooking stone 114 that is positioned on the grill section of the barbecue grill. A heating unit 116 extends through the first side wall 115. A vent 118 extends through the second side wall 120. A second cooking stone 122 is positioned on top of the roof or top 124 of the chamber. The heating element in the depicted embodiment is meeting a flame 126 that extends over a pizza 128 and cooked upon the chamber floor 114. The controls 130 of the gas grill are set to an on position causing heat to be generated from beneath the cooking stone 114 and grill (not shown as it is obscured by stone 114). A second pizza 132 is position on the top surface 134 of roof top 122 of the chamber. The flame 126 is being directed horizontally across the upper section of the chamber defined by the chamber of the aperture. This directs the heat and exhaust gases across the chamber to the vent 118. In FIG. 16A the lid 136 of the barbecue grill is in the open position to illustrate the grill top pizza oven.

FIG. 16B illustrates a second view of the chamber 110 positioned on top of the grill of the barbecue grill 112. The heating element 116 is shown dispensing a flame or heat 126 across the upper section of the chamber 113. FIG. 16B further illustrates the chamber defined by the first side wall 115 second side wall 120 and back wall 117. The aperture in the second side wall is shown leading to the vent through the side wall of the barbecue grill lid 136.

FIG. 16C illustrates the barbecue grill in a closed position. In the depicted embodiment the vent 118 extends through the side wall of the lid 136 of the barbecue grill. The control 142 of the supplemental burner 116 of the grill top pizza oven is shown extending through the opposite side wall of the lid of the barbecue grill from the vent. Alternatively, the vent can be configured to extend upward through the top of the lid of the barbecue grill. This can be used in larger barbecue grills that have grill space to allow for the vent to extend within the cooking space of the barbecue grill.

FIG. 16D illustrates one of the potential beneficial uses of the disclosed grill top pizza oven. The floor of the chamber is a cooking stone 114 positioned on the grill 148 of the barbecue grill. The cooking stone can be removable. Alternatively the floor can be integral with the wall(s) of the chamber. The lower pizza stone has a pizza 128 that is being cooked on the lower stone within the chamber. The top surface 122 of the top of the chamber has two pizzas 132, 133 that are being staged and kept warm by a pizza stone forming the top surface of the chamber top, as well as the heat being retained within the cooking space of the grill by the grill lid 136. The depicted use allows for multiple pizzas to be cooked at different times and served simultaneously while maintaining an appropriate serving temperature of each pizza.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A grill top pizza oven for positioning on the grill of a barbecue grill, the barbecue grill comprising a barbecue grill heat source positioned below the barbecue grill and a lid for closing the barbecue grill to form a barbecue grill cooking space, the grill top pizza oven comprising:
a chamber defined by at least one chamber wall and a chamber top;
a base configured for positioning on the grill of the barbecue grill;
a chamber heat source extending through said chamber wall and configured to distribute heat into the chamber between the grill and the chamber top;
a vent positioned in said side wall and/or said top; and
wherein said chamber wall comprises a chamber opening configured to receive a pizza within said chamber for cooking of said pizza.

2. The grill top pizza oven wherein said chamber further comprises a floor positioned within said chamber on said grill and configured as a pizza cooking surface.

3. The grill top pizza oven of claim 2 wherein said floor is removable.

4. The grill top pizza oven of claim 2 wherein said floor is a pizza stone.

5. The grill top pizza oven of claim 1 wherein said grill top pizza oven comprises two side walls and a back wall.

6. The grill top pizza oven of claim 5 wherein said chamber heat source extends through a first side wall of said two side walls.

7. The grill top pizza oven of claim 6 wherein said vent is positioned in a second side wall of said two side walls.

8. The grill top pizza oven of claim 1 wherein said vent is a horizontal vent.

9. The grill top pizza oven of claim 1 wherein said vent is a vertical vent.

10. The grill top pizza oven of claim 1 wherein a bottom of said side wall forms said base.

11. The grill top pizza oven of claim 1 wherein a top surface of said chamber top comprises a pizza staging surface.

12. The grill top pizza oven of claim 1 further comprising a multipurpose cooking base, wherein said multipurpose cooking base comprising:
a base cooking surface;
a plurality of legs supporting said base cooking surface; and
wherein said grill top pizza oven is removably attachable to said multipurpose cooking base so as to be interchangeable between said multipurpose cooking base and the barbecue grill.

13. The grill top pizza oven of claim 1 wherein said multipurpose cooking base comprises a base heat source positioned below said cooking surface.

14. The grill top pizza oven of claim 12 wherein said base heat source comprises a gas heat source.

15. The grill top pizza oven of claim 11 wherein said base comprises a door configured to close said chamber opening.

16. A combination of a grill top pizza oven and barbecue grill, the grill top pizza oven positioned on a grill of the barbecue grill, wherein:
the barbecue grill comprising a barbecue grill heat source positioned below the grill and a lid for closing the barbecue grill to form a barbecue grill cooking space above said grill;
the grill top pizza oven comprising:
a chamber defined by at least one chamber wall and a top, wherein a top surface of said top comprises a pizza staging surface;
a base configured for positioning on the grill of the barbecue grill;
a chamber heat source extending through said side wall and configured to distribute heat into said chamber above said grill;
a vent positioned in said side wall and/or said top; and
wherein said chamber wall defines a chamber opening configured to receive a pizza within said chamber for cooking of said pizza.

17. The combination of a grill top pizza oven and barbecue grill of claim 15 wherein said chamber comprises a chamber floor, wherein said chamber floor is configured as a cooking surface.

18. The combination of a grill top pizza oven and barbecue grill of claim 15 wherein a top surface of said chamber top is configured for staging cooked food between said chamber top and a lid of said grill when said lid is closed.

19. The combination of a grill top pizza oven and barbecue grill of claim 15 wherein said vent comprises a conduit extending through said lid when said lid is closed.

20. The combination of a grill top pizza oven and barbecue grill of claim 15 further comprising a separate multipurpose cooking base, wherein said multipurpose cooking base comprising:
a base cooking surface;
a plurality of legs supporting said base cooking surface; and
wherein said grill top pizza oven is configured to be interchangeable from said barbecue grill to said multipurpose cooking base so as to be interchangeable between said multipurpose cooking base and the barbecue grill.
